(19) United States
(12) Patent Application Publication
(10) Pub. No.: US 2023/0043224 A1
(43) Pub. Date: Feb. 9, 2023

(54) MANAGEMENT APPARATUS

(71) Applicant: NTT DOCOMO, INC., Chiyoda-ku (JP)

(72) Inventors: Sadaatsu KATOU, Chiyoda-ku, (JP); Kengo MATSUMOTO, Chiyoda-ku, (JP); Hironori ISHIKAWA, Chiyoda-ku (JP)

(73) Assignee: NTT DOCOMO, INC., Chiyoda-ku (JP)

(21) Appl. No.: 17/758,810

(22) PCT Filed: Dec. 3, 2020
(86) PCT No.: PCT/JP2020/044976

§ 371 Date: Jul. 14, 2022

(30) Foreign Application Priority Data
Jan. 17, 2020 (JP) 2020-005608

(51) Int. Cl. G06Q 10/02

(52) U.S. Cl. CPC G06Q 10/02

(57) ABSTRACT

A management apparatus for managing facility reservations, includes: a generator configured to generate a learning model that is used for a non-fulfillment estimation to estimate whether a reservation of a facility will not be fulfilled, the learning model corresponding to: an estimation timing at which the non-fulfillment estimation is performed, and a use timing at which the facility designated by a reservation as a subject of the non-fulfillment estimation is used; and an estimator configured to use the learning model to perform the non-fulfillment estimation.

### TECHNICAL FIELD

The present invention relates to management apparatuses.

### BACKGROUND ART

In a reservation management system that manages reservations of facilities such as a conference room, there is disclosed a management method for managing whether a reserved facility is actually being used as reserved (for example, Patent Document 1). In this type of management method, for example, by letting users other than the reservation holder of a reserved (but unused conference room) use it, conference rooms can be used effectively.

### RELATED ART DOCUMENT

### Patent Document

Patent Document 1: Japanese Patent Application Laid-Open Publication No. 2011-96191

### SUMMARY OF THE INVENTION

### Problem to be Solved by the Invention

However, in such a conventional management method, users other than the reservation holder of a conference room do not know whether the conference room is used as reserved until the scheduled start time of the conference. Therefore, usability of a reservation management system employing the conventional management method is not necessarily optimal.

### Means for Solving the Problems

To solve the above problem, a management apparatus for managing facility reservations according to the present invention, includes: a generator configured to generate a learning model that is used for a non-fulfillment estimation to estimate whether a reservation of a facility will not be fulfilled, the learning model corresponding to: an estimation timing at which the non-fulfillment estimation is performed, and a use timing at which the facility designated by a reservation as a subject of the non-fulfillment estimation is used; and an estimator configured to use the learning model to perform the non-fulfillment estimation.

### Effect of the Invention

According to the present invention, usability of a reservation management system can be improved.

### BRIEF DESCRIPTION OF THE DRAWINGS

FIG. 1 is a block diagram illustrating an overall configuration of a reservation management system including a management apparatus according to a first embodiment.

FIG. 2 is an explanatory diagram illustrating an example of reservation management information stored in a reservation management table.

FIG. 3A is an explanatory diagram illustrating an example of feature amounts used as a part of teaching data in a learning model.

FIG. 3B is an explanatory diagram illustrating continuation of the example of feature amounts used as a part of teaching data in a learning model.

FIG. 4 is an explanatory diagram for explaining an outline of operations of the management apparatus when a non-fulfillment estimation is performed.

FIG. 5 is an explanatory diagram illustrating an example of learning models used for a non-fulfillment estimation.

FIG. 6 is a flowchart illustrating an example of operations of the management apparatus when a non-fulfillment estimation is performed.

FIG. 7 is a flowchart illustrating an example of operations of the management apparatus when a learning model is generated.

FIG. 8 is a block diagram illustrating an overall configuration of a reservation management system including a management apparatus according to a second embodiment.

FIG. 9 is an explanatory diagram illustrating an example of a schedule screen.

FIG. 10 is a flowchart illustrating an example of operations of the management apparatus illustrated in FIG. 8.

### MODES FOR CARRYING OUT THE INVENTION

### 1. First Embodiment

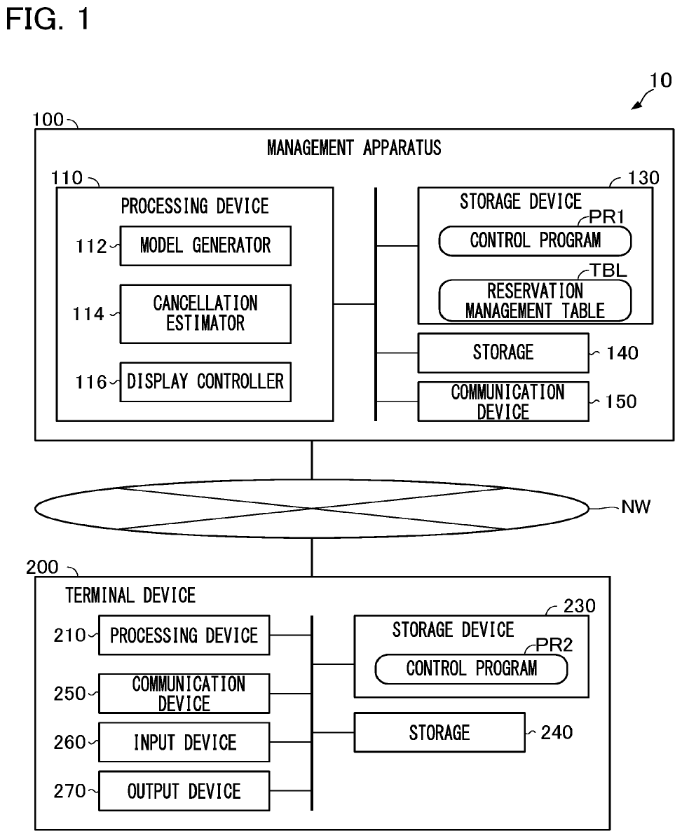

FIG. 1 is a block diagram illustrating an overall configuration of a reservation management system 10 including a management apparatus 100 according to a first embodiment. The reservation management system 10 manages reservations for use of services. For example, the reservation management system 10 includes the management apparatus 100 that manages reservations for use of services, a terminal device 200 that can be operated by users of the reservation management system 10, and a network NW. The network NW is, for example, a telecommunications line such as a mobile communications network, and includes one or both of a wired network and a wireless network. The management apparatus 100 and the terminal device 200 are communicable with each other via the network NW.

The use of services may be use of a facility such as a conference room (meeting room), an accommodation facility, or use of a restaurant and the like. Alternatively, the use of services may be use of rental services of goods such as a car and electronic equipment. In the present embodiment, for the use of services, use of a conference room is assumed. That is, in the present embodiment, as a reservation for use of services, a reservation for a conference room is assumed. The reservation of a conference room may include a reservation for use of a predetermined area in an open space.

The management apparatus 100 is, for example, an information processing device such as a computer system and manages reservations of conference rooms. For example, the management apparatus 100 is implemented by a computer system including a processing device 110, a storage device 130, a storage 140, and a communication device 150. The plurality of elements in the management apparatus 100 are connected to one another via a single bus or multiple buses to communicate information. The term “device (apparatus)” in the present specification may be rephrased using another term such as circuit, device, or unit. Furthermore, each of the plurality of elements in the management apparatus 100 may be constituted of a single device or a plurality of devices. Alternatively, some part of the management apparatus 100 may be omitted.

The processing device 110 is a processor that controls the entirety of the management apparatus 100 and is constituted of, for example, a single chip or multiple chips. The processing device 110 is constituted of, for example, a CPU (Central Processing Unit) including an interface with peripheral devices, an arithmetic device, a resistor, and the like. Some or all of the functions of the processing device 110 may be realized by hardware such as a DSP (Digital Signal Processor), an ASIC (Application Specific Integrated Circuit), a PLD (Programmable Logic Device), and an FPGA (Field Programmable Gate Array). The processing device 110 performs various types of processing in parallel or sequentially.

For example, the processing device 110 reads out a control program PR1 from the storage device 130 and executes the read out control program PR1, thereby functioning as a model generator 112, a cancellation estimator 114, and a display controller 116. The control program PR1 may be transmitted from other devices via the network NW.

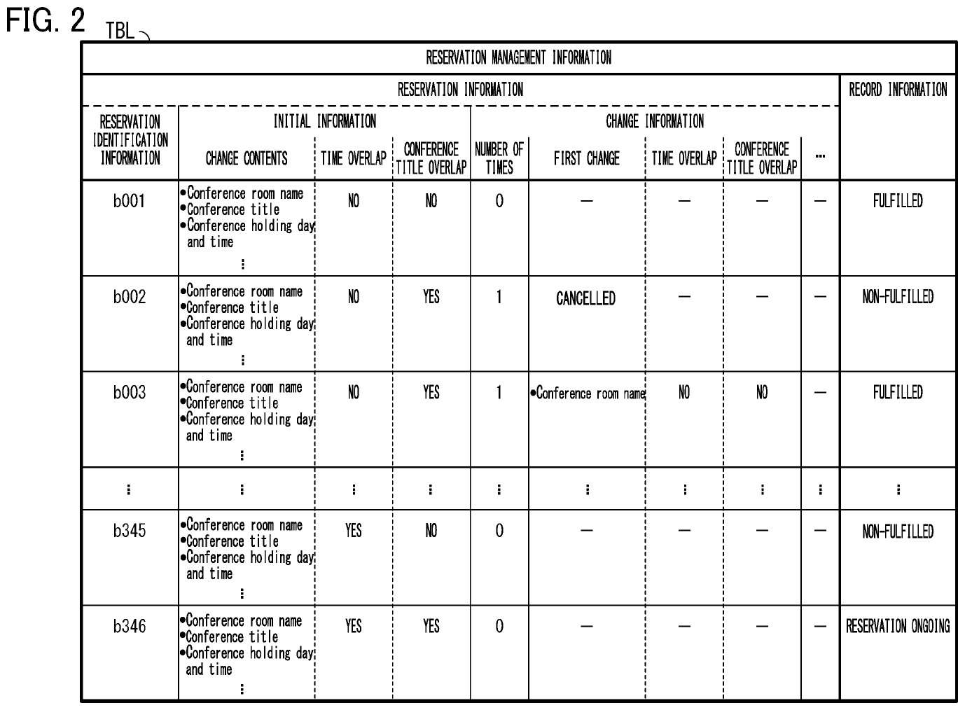

For example, the model generator 112 generates a learning model used for a non-fulfillment estimation to estimate whether a reservation for a conference room is not fulfilled using teaching data based on reservation management information regarding the reservation for the conference room. The reservation management information is, for example, stored in a reservation management table TBL. Details of reservation management information stored in the reservation management table TBL are explained with reference to FIG. 2, described later.

Examples of a case in which a reservation is canceled with the reservation management system 10 include a case of non-usage of a conference room in a state of being reserved with the reservation management system 10, and the like, correspond to non-fulfillment of a conference room reservation.

In the following descriptions, a conference room in a state of being reserved with the reservation management system 10 has not been used is also referred to as “cancellation without notice.”

In the following descriptions, a case in which a reservation is canceled in the reservation management system 10 and cancellation without notice may be referred to as “cancellation”, whereas these cases are not specifically distinguished from each other. That is, in the following descriptions, non-fulfillment of a reservation may be referred to as “reservation being canceled.”

For example, the model generator 112 generates a learning model corresponding to an estimation timing at which a non-fulfillment estimation is performed and a use timing at which a conference room designated by a reservation as a subject of the non-fulfillment estimation is used.

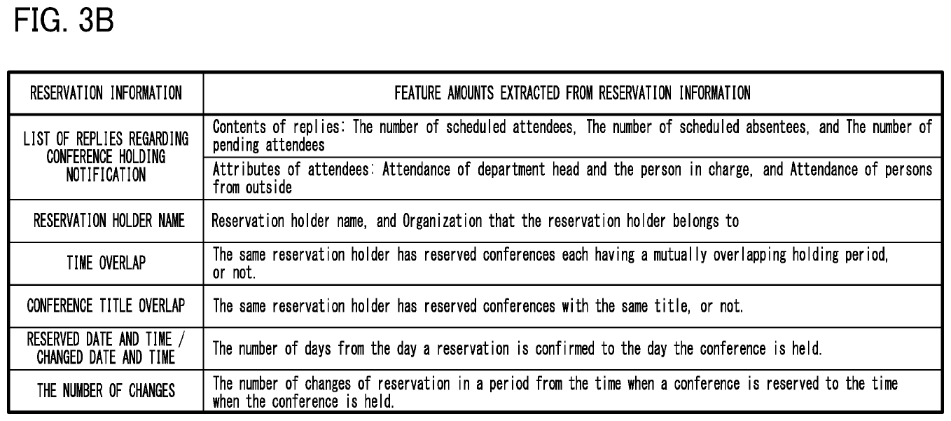

Accordingly, a learning model corresponding to an estimation timing and a use timing is generated. The model generator 112 is an example of a generator. Specific operations of the model generator 112 are explained with reference to FIG. 4 and the subsequent figures, described later.

The cancellation estimator 114 performs a non-fulfillment estimation using the learning model generated by the model generator 112. With this process, for example, whether the probability of cancellation is equal to or greater than a predetermined value is estimated. The cancellation estimator 114 is an example of an estimator.

The display controller 116 generates display information for displaying a schedule screen that shows a reservation status of a conference room. The display controller 116 then transmits display information to the terminal device 200. With this process, a schedule screen is displayed on an output device 270 of the terminal device 200. The output device 270 will be described later.

The storage device 130 is a recording medium readable by the processing device 110 and stores therein a plurality of programs including the control program PR1 executed by the processing device 110 and various types of data such as the reservation management table TBL used by the processing device 110. The storage device 130 may be constituted of at least one of a ROM (Read Only Memory), an EPROM (Erasable Programmable ROM), an EEPROM (Electrically Erasable Programmable ROM), a RANI (Random Access Memory), and the like. The storage device 130 may be also referred to as “resistor,” “cache,” “main memory,” or the like.

The storage 140 is a recording medium readable by the processing device 110. The storage 140 may be constituted of, for example, at least one of an optical disc such as a CD-ROM (Compact Disc ROM), a hard disk drive, a flexible disk, a magnetooptical disk (such as a compact disc, a digital versatile disc, and a Blu-ray® disc), a smart card, a flash memory (such as a card, a stick, and a key drive), a Floppy® disk, a magnetic strip, and the like. The storage 140 may be referred to as “auxiliary storage device.” The storage mediums mentioned above may be a database, a server, or another type of appropriate medium including one or both of the storage device 130 and the storage 140.

The communication device 150 is hardware (a transmitting and receiving device) that communicates with other devices via the network NW. The communication device 150 is also referred to as, for example, “network device,” “network controller,” “network card,” or “communication module.” The communication device 150 may be configured to include, for example, a high-frequency switch, a duplexer, a filter, a frequency synthesizer, and the like in order to realize any one or both of FDD (Frequency Division Duplex) and TDD (Time Division Duplex).

The terminal device 200 is, for example, a terminal information device such as a personal computer. The terminal device 200 may be a portable information terminal such as a laptop computer, a tablet terminal, a wearable terminal, and a smartphone.

For example, the terminal device 200 is realized by a computer system including a processing device 210, a storage device 230, a storage 240, a communication device 250, an input device 260, and an output device 270. The processing device 210 is a processor that controls the entirety of the terminal device 200 and is configured substantially the same as the processing device 110 of the management apparatus 100 described above. For example, the processing device 210 reads out a control program PR2 from the storage device 230 and executes the read out control program PR2, thereby causing the terminal device 200 to function as a terminal that accepts operations regarding reservations of conference rooms.

For example, an operation for displaying a schedule screen showing a reservation status of a conference room, an operation for reserving a conference room, an operation for changing a reservation of a conference room, an operation for canceling a reservation of a conference room, and the like correspond to the operations regarding reservations of conference rooms.

The control program PR2 may be transmitted from other devices via the network NW.

The storage device 230 is a recording medium readable by the processing device 210 and stores therein a plurality of programs including the control program PR2 executed by the processing device 210 and various types of data used by the processing device 210. The storage device 230 may be constituted of at least one of a ROM, an EPROM, an EEPROM, a RAM, and the like in a manner substantially the same as the storage device 130 described above. The storage 240 is, substantially the same as the storage 140 described above, a recording medium readable by the processing device 210. The communication device 250 is hardware (a transmitting and receiving device) that communicates with other devices via the network NW and is configured in a manner substantially the same as the communication device 150 described above.

The input device 260 is an input device (such as a keyboard, a mouse, a microphone, a switch, a button, and a sensor) that accepts input from the outside. For example, the input device 260 accepts an operation for inputting signs such as numerals and characters to the processing device 210 and an operation for selecting icons displayed on a display screen of the terminal device 200. The input device 260 may include a plurality of operators that can be operated by a user.

The output device 270 is an output device such as a display that executes output to the outside. For example, the output device 270 displays a schedule screen and the like under control of the processing device 210. Various types of display panels such as a liquid-crystal display panel and an organic EL (Electroluminescent) display panel are preferably used as the output device 270.

The input device 260 and the output device 270 may be an integrated constitution (such as a touch panel that detects contact on a display screen). The output device 270 may be an output device including a speaker, an LED (Light Emitting Diode) lamp, and the like.

The configurations of the management apparatus 100 and the terminal device 200 are not limited to the example illustrated in FIG. 1. The management apparatus 100 may include an input device and an output device in a manner substantially the same as the terminal device 200. The reservation management table TBL may be stored in the storage 140. The storage 240 may be omitted from the terminal device 200.

FIG. 2 is an explanatory diagram illustrating an example of reservation management information stored in the reservation management table TBL. The reservation management table TBL is referenced when, for example, a process such as generating a learning model or generating display information for displaying a schedule screen is performed. For example, when a learning model is generated, the model generator 112 acquires the reservation management table TBL from the storage device 130. Subsequently, the model generator 112 generates teaching data based on the reservation management information stored in the reservation management table TBL and generates a learning model using the generated teaching data.

As described above, in the reservation management table TBL, reservation management information regarding reservations of conference rooms is stored. The reservation management information includes, for example, record information indicating a record as to whether a reservation of a conference room has been fulfilled and reservation information regarding reservations corresponding to the record indicated by the record information. The reservation information includes information regarding histories of reservations (such as registrations and changes of reservations).

The reservation information includes reservation identification information, initial information, and change information. The reservation identification information is information for identifying each reservation among a plurality of reservations regarding one or multiple conference rooms managed by the management apparatus 100. The initial information indicates reservation contents, whether there is any time overlap, and whether there is any conference title overlap at the time when the reservation indicated by the reservation identification information is first made. For example, pieces of information such as conference room name, conference title, conference holding date and time, list of names of participants participating in the conference, list of replies regarding conference holding notification, reservation holder name, and date and time the reservation is made correspond to the reservation contents.

Information regarding whether there is any time overlap indicates, for example, whether the reservation holder of a reservation indicated by reservation identification information has reserved a conference having a holding period that overlaps with the holding period of the conference corresponding to the reservation indicated by the reservation identification information.

For example, when a first conference corresponding to the reservation indicated by the reservation identification information and a second conference being held on the same date as the first conference are reserved by the same reservation holder, the fact that there is a time overlap may indicate that a part or all of the period from the start time to the finish time of the first conference overlaps with a part or all of the period from the start time to the finish time of the second conference.

At a stage of making a reservation, the start time of a conference is a scheduled start time and the finish time of the conference is a scheduled finish time. Information regarding whether there is any conference title overlap indicates, for example, whether the reservation holder of a reservation indicated by reservation identification information has reserved a conference having the same title as the title of the conference corresponding to the reservation indicated by the reservation identification information.

Change information indicates the number of changes of a reservation indicated by reservation identification information, changed contents at the time of changing a reservation, whether there is any time overlap, and whether there is any conference title overlap. The change contents at the time of changing a reservation indicates, for example, contents changed in the reservation contents before change. Furthermore, the change contents indicates, for example, cancellation of a reservation when the reservation has been canceled. Information regarding whether there is any time overlap indicates whether there is any time overlap in a changed reservation. Similarly, information regarding whether there is any conference title overlap indicates whether there is any conference title overlap in a changed reservation.

In the example illustrated in FIG. 2, the change information includes, when there are multiple times of changes, changed contents, information regarding whether there is any time overlap, and information regarding whether there is any conference title overlap in each of the multiple times of changes.

When there are changes greater than a predetermined number of times, it is possible to employ a mode in which changed contents, information regarding whether there is any time overlap, and information regarding whether there is any conference title overlap from the latest change to a change traced back for a predetermined number of times are included in the change information, and changed contents, information regarding whether there is any time overlap, and information regarding whether there is any conference title overlap with respect to other changes are not included in the change information.

The record information indicates a record as to whether a reservation indicated by reservation identification information has been fulfilled. The “fulfilled” illustrated in FIG. 2 represents that a reserved conference room has been used for at least part of a period from the start time of the conference reservation to the end time thereof. The “non-fulfillment” illustrated in FIG. 2 represents that a reservation has been canceled (including cancellation without notice). The “reservation ongoing” in the drawing represents that the time when the reservation management table TBL is updated does not match the end time of the conference reservation.

Determination as to whether a conference room has been used may be realized by providing, in a conference room, at an entrance, or the like of the conference room, a sensor that detects whether any person is present in the conference room. In this case, the management apparatus 100 acquires a detection result of the sensor by performing communication with the sensor via the network NW or the like. The management apparatus 100 then determines whether the conference room has been used based on the detection result of the sensor.

The sensor may be any one of an opening-closing sensor that detects opening and closing of a door, an illumination sensor that detects whether there is light, and a human detecting sensor or a combination of these sensors. The opening-closing sensor may be provided in a conference room as an individual room with a door. The illumination sensor may be provided in an open space where no opening-closing sensor can be provided. For example, when an open space is used, lights such as electric lights are used, and thus, the illumination therein is assumed to be high. In an open space in which no lights or the like are provided, a human detecting sensor may be provided. The human detecting sensor detects presence of persons by using, for example, any one or more of infrared light, ultrasonic waves, visible light, and the like.

It is also possible that, as a user operates a device (such as a telephone and the terminal device 200) provided in a conference room, information indicating that the conference room has been used is transmitted to the management apparatus 100. In this case, a sensor that detects whether there is any person in the conference room does not need to be provided in the conference room.

The reservation management table TBL is not limited to the example illustrated in FIG. 2. For example, among the reservation management information, information referenced when a process of generating display information for displaying a schedule screen (such as information indicating the latest reservation contents) may be managed by a table other than the reservation management table TBL.

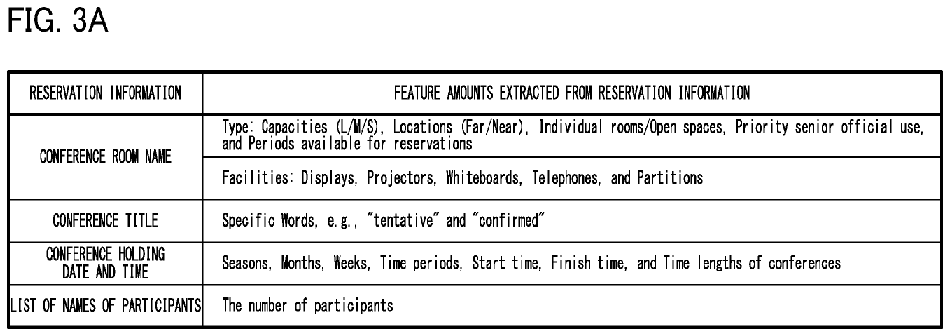

FIG. 3A is an explanatory diagram illustrating an example of feature amounts used as a part of teaching data in a learning model. FIG. 3B is an explanatory diagram illustrating continuation of the example of feature amounts used as a part of teaching data in a learning model. In the following descriptions, there are cases in which FIG. 3A and FIG. 3B are collectively referred to as “FIGS. 3.” For example, the teaching data includes the feature amounts illustrated in FIG. 3 (feature amounts extracted from the reservation information illustrated in FIG. 2) and the record information illustrated in FIG. 2. Although details thereof are described later with reference to FIG. 4, reservation information as a subject of extracting feature amounts is selected according to an estimation timing at which a non-fulfillment estimation is performed and a use timing of a conference room designated by a reservation as a subject of the non-fulfillment estimation. Extraction of feature amounts from the reservation information is performed by, for example, the model generator 112.

For example, the model generator 112 extracts feature amounts regarding a conference room type and feature amounts regarding conference room facilities based on type information regarding the type of a conference room being associated with a conference room name and facility information regarding the facilities of the conference room.

Type information and facility information that are associated with conference-room identification information for identifying each conference room among a plurality of conference rooms may be stored in the storage device 130 or the storage 140.

A conference room size, a conference room location, a conference room form, whether any priority is set, a period in which reservations can be made, and the like correspond to the feature amounts regarding the conference room type. The information indicating the conference room size may be information indicating any one or both of a size sorted as “large (L),” “medium (M),” “small (S),” and the like, and the capacity. The information indicating the conference room location may be information indicating whether it is far or near from a place where a reservation holder is present. The information indicating the conference room form may be whether the conference room is an individual room or an open space. The information indicating whether any priority is set may be information indicating whether there is any priority set such that certain persons such as senior officials can preferentially use the conference room. The information indicating the period in which reservations can be made may be information indicating how many days before the date the conference will be held the reservations can be made.

For example, whether each of a display, a projector, a whiteboard, a telephone, and partitions are provided in a conference room corresponds to the feature amounts regarding conference room facilities.

For example, whether any specific words such as “tentative” and “confirmed” are included in a conference title corresponds to the feature amounts extracted from the conference title.

For example, the season the conference is held, the month the conference is held, the day of the week the conference is held, the time period of day the conference is held, the start time of the conference, the end time of the conference, the time length of the conference, and the like correspond to the feature amounts extracted from a conference holding day and time. The number of participants who participate in the conference corresponds to the feature amounts extracted from a list of names of participants.

For example, feature amounts regarding contents of replies, feature amounts regarding attributes of attendees, and the like, are extracted from a list of replies regarding conference holding notification. For example, the number of scheduled attendees, the number of scheduled absentees, the number of pending attendees, and the like correspond to the feature amounts regarding contents of replies. The pending attendees are, for example, persons for whom the decisions to attend are pending. The persons for whom the decisions to attend may be persons who have not yet replied to conference holding notification. For example, whether each of a department head and a person in charge will attend and whether any person from outside will attend correspond to the feature amounts regarding attributes of attendees.

For example, the reservation holder name, the organization the reservation holder belongs to, and the like correspond to feature amounts extracted from the reservation holder name. The reservation holder name may be user identification information for identifying the reservation holder from a plurality of users. Alternatively, in addition to the reservation holder name, user identification information on the reservation holder may correspond to the feature amounts.

From a time overlap, for example, a feature amount indicating whether the same reservation holder has reserved a plurality of conferences each having a mutually overlapping holding period may be extracted. Furthermore, from a conference title overlap, for example, a feature amount indicating whether the same reservation holder has reserved a plurality of conferences with the same title may be extracted.

A feature amount extracted from a reserved date and time and a changed date and time may be the number of days from the day a reservation is confirmed to the day the conference is held. Furthermore, a feature amount extracted from the number of changes may be the number of changes of reservation in a period from the time when a conference is reserved to the time when the conference is held. For example, when a large number of changes to a reservation is made, as compared to a case in which a small number of changes to a reservation is made, the probability of the reservation being canceled is assumed to be lower.

For example, the model generator 112 generates a learning model using teaching data including some or all of the plurality of feature amounts illustrated in FIG. 3 and the record information illustrated in FIG. 2. As for the feature amounts included in the teaching data, feature amounts other than the plurality of feature amounts illustrated in FIG. 3 may be included in the teaching data in place of some of the plurality feature amounts illustrated in FIG. 3 or while being added to the plurality of feature amounts illustrated in FIG. 3.

For example, when a non-fulfillment estimation is performed, the cancellation estimator 114 may perform the non-fulfillment estimation by extracting a feature amount corresponding to a feature amount used as teaching data from reservation information on a reservation as a subject of a non-fulfillment estimation and using the extracted feature amount as input to a learning model. In the example illustrated in FIGS. 3, when a non-fulfillment estimation is performed, the cancellation estimator 114 may perform the non-fulfillment estimation by extracting some or all of the plurality of feature amounts illustrated in FIG. 3 from reservation information on a reservation as a subject of the non-fulfillment estimation and using the extracted feature amounts as input into a learning model.

FIG. 4 is an explanatory diagram for explaining an outline of operations of the management apparatus 100 when a non-fulfillment estimation is performed. A date and time DT illustrated in FIG. 4 represents, for example, a date and a time. In FIG. 4, it is assumed that the unit of interval between an estimation timing at which a non-fulfillment estimation is performed and a use timing of a conference room designated by a reservation as a subject of the non-fulfillment estimation is the unit of days. The unit of interval between the estimation timing and the use timing is not limited to the unit of days. For example, the unit of interval between the estimation timing and the use timing may be in the unit of hours (the unit of 60 minutes) or in the unit of minutes.

In FIG. 4, a case will be given in which a non-fulfillment estimation is performed on a date and time DTc with respect to a reservation of reservation identification information “b400.”

Furthermore, in FIG. 4, a conference holding date and time indicated by reservation information on the reservation of the reservation identification information “b400” is a date and time DTd that is N days (N is a natural number equal to or greater than 1) after the date and time DTc. In this case, the date DTc is an example of the estimation timing at which the non-fulfillment estimation is performed, and the date and time DTd is an example of the use timing of a facility designated by a reservation as a subject of the non-fulfillment estimation. Furthermore, N days from the date and time DTc to the date and time DTd is an example of a second period.

In FIG. 4, a case will be given in which records of six reservations are confirmed before the date and time DTc. The six reservations among a plurality of reservations are a reservation of reservation identification information “b200,” a reservation of reservation identification information “b220,” a reservation of reservation identification information “b240,” a reservation of reservation identification information “b260,” a reservation of reservation identification information “b280,” and a reservation of reservation identification information “b282.”

In FIG. 4, each of the double circles represents a date and time a reservation is registered (for example, a date and time corresponding to a date and time the initial information in FIG. 2 is registered), and each of the white circles represents a date and time a reservation is changed (for example, a date and time corresponding to a date and time the change information in FIG. 2 is updated). Furthermore, in FIG. 4, each of the black circles and each of the crosses represents a conference holding date and time indicated by reservation information. The black circles represent a fact that a reservation has been fulfilled and the crosses represent a fact that a reservation has not been fulfilled.

In FIG. 4, each of the white circles covered with a cross represents a fact that a reservation has been canceled in the reservation management system 10. A period (each of the shaded portions in FIG. 4) preceding by N days from the conference holding date and time represented by a black circle or a cross is an example of a first period. Furthermore, registrations and changes of reservations are examples of histories of reservations. For example, the start timing of each of the shaded portions in FIG. 4 corresponds to a first timing and the end timing (a conference holding date and time represented by a black circle or a cross) of each of the shaded portions corresponds to a second timing and an origination.

The reservation of the reservation identification information “b200” is, for example, a reservation of a conference room A, and the reservation contents thereof have been changed three times before the reservation is fulfilled. For example, in the reservation of the reservation identification information “b220,” the conference room A is reserved with the first reservation, and it is changed from the conference room A to a conference room B at the third change of the reservation. Subsequently, in the reservation of the reservation identification information “b220,” the reservation is fulfilled as the conference room B is used.

For example, the reservation of the reservation identification information “b240” is a reservation that the conference room B is not used because it is canceled at the third change of the reservation. Similarly, the reservation of the reservation identification information “b280” is a reservation that the conference room B is not used because it is canceled at the second change of the reservation. In addition, the reservation of the reservation identification information “b260” is a reservation that a reserved conference room B is not used (a reservation canceled without notice) although no cancellation has been made in the reservation management system 10. For example, in the reservation of the reservation identification information “b282,” the reservation is fulfilled as a conference room C is used without changing the reservation contents.

Since the conference holding date and time (the date and time DTd) indicated by the reservation information on the reservation of the reservation identification information “b400” is N days after the current time (the date and time DTc), the model generator 112 generates a learning model used for a non-fulfillment estimation of a conference to be held N days later. For example, the model generator 112 generates a learning model using teaching data based on record information indicating a record as to whether a reservation of a conference room has been fulfilled, reservation information regarding histories (such as registrations and changes of reservations) of a reservation corresponding to the record indicated by the record information.

Since the use timing (the date and time DTd) is N days (N is a natural number equal to or greater than 1) after the estimation timing (the date and time DTc), the reservation information used for generating the teaching data does not include information corresponding to histories in a period (each of the shaded portions in FIG. 4) until N days before the conference holding date and time indicated by reservation identification information in which a record of reservation is confirmed before the use timing (the date and time DTd). That is, the reservation information used for generating the teaching data does not include information corresponding to reservations having been made during the period represented by the shaded portions in FIG. 4. The conference holding date and time indicated by reservation identification information in which a record of reservation is confirmed before the use timing (the date and time DTd) is an example of a use date of a facility designated by a reservation corresponding to a record indicated by record information.

In the example illustrated in FIG. 4, among the reservation information each corresponding to the six reservations, which are the reservation identification information “b200,” “b220,” “b240,” “b260,” “b280,” and “b282,” the feature amount described with reference to FIG. 3 is extracted, as a feature amount included in the teaching data, from information having information corresponding to registrations and changes of reservations included in the shaded portions omitted therefrom. Specifically, change information corresponding to the third change of the reservation of the reservation identification information “b200,” change information corresponding to the second and third changes of the reservation of the reservation identification information “b220,” change information corresponding to the third change of the reservation of the reservation identification information “b240,” and reservation information corresponding to the reservation of the reservation identification information “b282” are not included in the reservation information on an extraction subject of the feature amount included in the teaching data.

The model generator 112 then uses teaching data including a record of reservations and a feature amount extracted from reservation information from which information corresponding to histories (registrations and change of reservations) in a period until N days before a conference holding date and time of a reservation having a record thereof already confirmed is omitted to generate a learning model used for a non-fulfillment estimation of a conference to be held N days later. In this manner, the model generator 112 generates a learning model corresponding to an estimation timing (the date and time DTc) and a use timing (the date and time DTd).

The cancellation estimator 114 uses a learning model (a learning model generated by the model generator 112) corresponding to the estimation timing (the date and time DTc) and the use timing (the date and time DTd) to perform a non-fulfillment estimation to estimate whether the reservation of the reservation identification information “b400” will be canceled. For example, the cancellation estimator 114 extracts the feature amount described with reference to FIG. 3 from the reservation information on the reservation of the reservation identification information “b400” (specifically, initial information, change information corresponding to the first change, and change information corresponding to the second change). The cancellation estimator 114 then inputs the feature amount extracted from the reservation information on the reservation of the reservation identification information “b400” to the learning model corresponding to the estimation timing (the date and time DTc) and the use timing (the date and time DTd). The cancellation estimator 114 estimates whether the reservation of the reservation identification information “b400” will be canceled based on an estimation value output from the learning model (that is, the probability of the reservation of the reservation identification information “b400” being canceled).

Since the reservation information corresponding to N days from the estimation timing (the date and time DTc) to the use timing (the date and time DTd) is reservation information regarding a period in the future; it does not exist at the current time point (the date and time DTc). Therefore, reservation information corresponding to N days from the estimation timing (the date and time DTc) to the use timing (the date and time DTd) is not included in reservation information on an extraction subject of the feature amount input to the learning model. In the present embodiment, as described above, since a learning model is generated using teaching data including a feature amount extracted from reservation information from which information corresponding to histories (registrations and changes of reservations) in a period until N days before a conference holding date and time of a reservation having a record thereof already confirmed is omitted, the feature amount included in the teaching data and the feature amount input to the learning model can be matched with each other.

In FIG. 4, when the reservation holder of the reservation of the reservation identification information “b280” is the same as the reservation holder of the reservation of the reservation identification information “b282,” there may be a case in which the reservation contents of the reservation identification information “b280” are changed to the reservation contents of the reservation identification information “b282” without canceling the reservation of the reservation identification information “b280.” In this case, reservation information corresponding to the second change of the reservation of the reservation identification information “b280” (changing the reservation contents to the reservation contents of the reservation identification information “b282”) is not included in the reservation information on the extraction subject of the feature amount included in the teaching data.

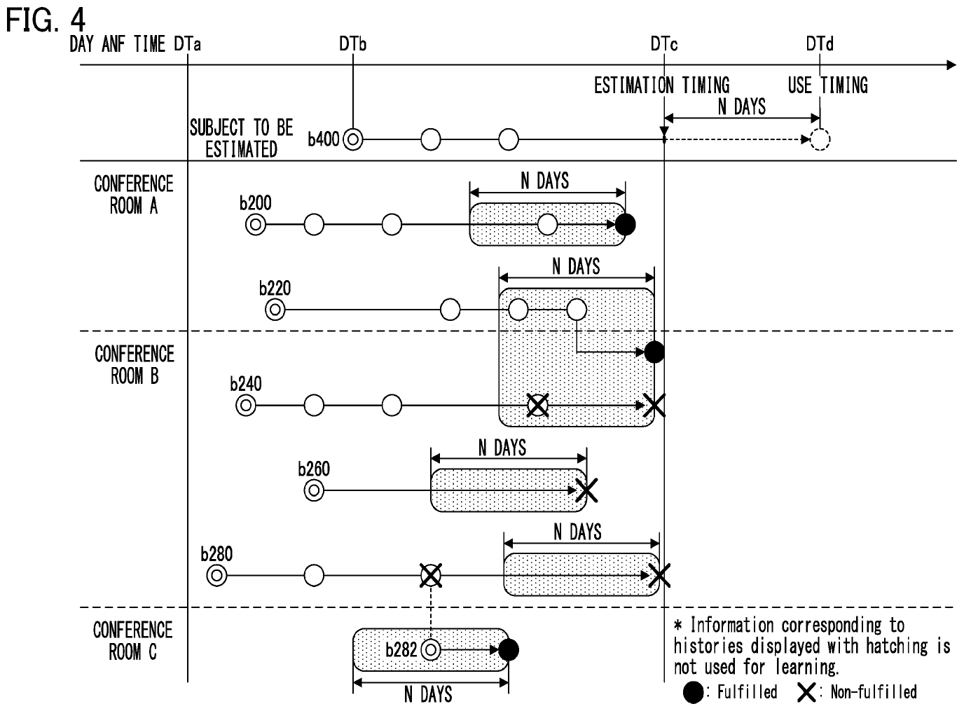

FIG. 5 is an explanatory diagram illustrating an example of learning models used for a non-fulfillment estimation. In FIG. 5, a decision tree is generated based on the feature amount (a feature amount extracted from reservation information) described with reference to FIGS. 3, 4, and the like.

The model generator 112 associates a feature amount extracted from reservation information with a plurality of nodes of a decision tree. Branches from a parent node to a child node represent conditions (bifurcations) that a feature amount corresponding to each node may take. A leaf node (a node not having any child node) represents an estimation value of a reservation being canceled (an estimation value obtained by a non-fulfillment estimation) with respect to a feature amount indicated by a path from a root node (a node not having any parent node). In the example illustrated in FIG. 5, an estimation value “0.7” is set with respect to a combination of feature amounts indicated by the path shown with the thick line.

The model generator 112 calculates, for example, an estimation result obtained by a non-fulfillment estimation regarding each of a plurality of reservations corresponding to the record included in teaching data based on an estimation value corresponding to a leaf node of a decision tree to be reached according to the feature amount included in the teaching data. For example, the model generator 112 estimates that a reservation is canceled when the estimation value is equal to or greater than 0.5, and estimates that a reservation is not canceled when the estimation value is less than 0.5. Thereafter, the model generator 112 calculates errors between the estimation result of each reservation and the record of each reservation. In the decision tree, the node, the conditions, and the estimation value thereof are changed from its current structure so as to reduce error. The decision tree is generated with a so-called “Gradient Boosting” method. That is, the model generator 112 generates a decision tree used for a non-fulfillment estimation by repeating changes of the node, the conditions, the estimation value, and the like of the decision tree so as to reduce errors.

The cancellation estimator 114 determines a path reaching a leaf node of a decision tree generated by the model generator 112 based on a feature amount extracted from reservation information on a reservation as a subject of a non-fulfillment estimation, thereby estimating the probability of reservation as the subject of the non-fulfillment estimation being canceled.

The type of decision trees is not limited to one. For example, decision trees of different types may be generated. In this case, the mean value of estimation values of decision trees of different types may be handled as an ultimate estimation value. The learning model is not limited to the decision tree.

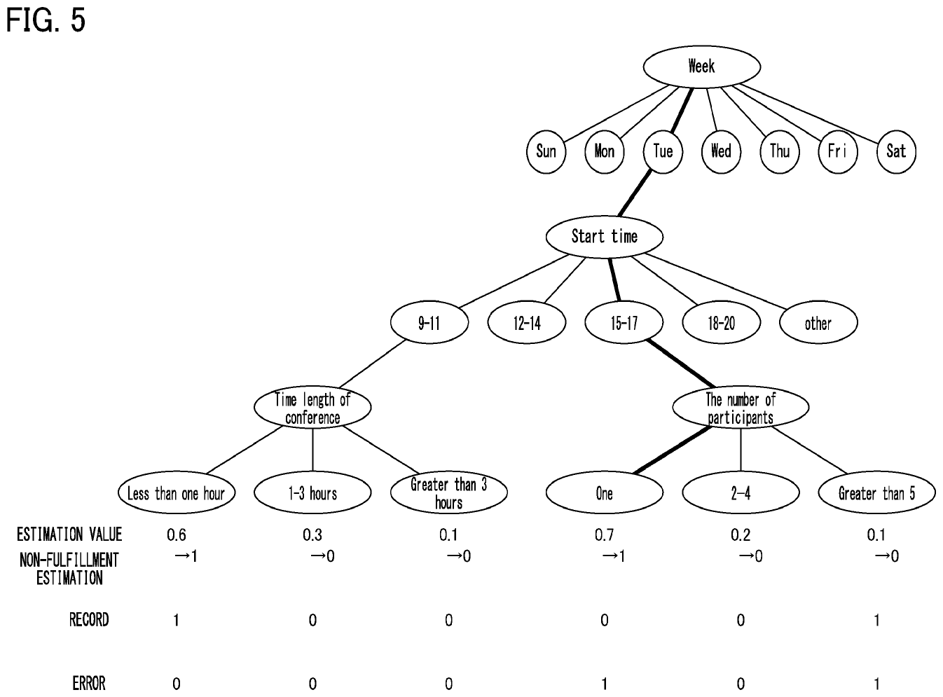

FIG. 6 is a flowchart illustrating an example of operations of the management apparatus 100 when a non-fulfillment estimation is performed. In FIG. 6, a case will be given in which a non-fulfillment estimation is performed every day at a predetermined time.

At Step S100, the cancellation estimator 114 estimates whether the current time is an estimation timing. For example, the cancellation estimator 114 estimates whether the current time is a predetermined time. When the determination result at Step S100 is YES, the cancellation estimator 114 proceeds the process to Step S200. When the determination result at Step S100 is NO, the cancellation estimator 114 returns the process to Step S100.

At Step S200, as described with reference to FIG. 4 and FIG. 5, the model generator 112 generates a learning model corresponding to an estimation timing and a use timing.

Next, at Step S300, as described with reference to FIG. 4 and FIG. 5, the cancellation estimator 114 performs a non-fulfillment estimation to estimate whether a reservation of a conference room is canceled using the learning model generated at Step S200. With this process, whether the reservation is canceled is estimated.

The operations of the management apparatus 100 are not limited to the operations illustrated in FIG. 6. For example, the determination at Step S100 may be performed by the model generator 112.

Furthermore, when a non-fulfillment estimation is performed every day at a first time in the morning and at a second time in the afternoon, the cancellation estimator 114 may determine whether the current time is the first time or the second time at Step S100. In this case, the cancellation estimator 114 may determine whether a learning model has already been generated before the process (generation of a learning model) at Step S200 is performed.

When the current time is the second time, a learning model generated at the first time may be used. In this case, the process at Step S200 may be omitted.

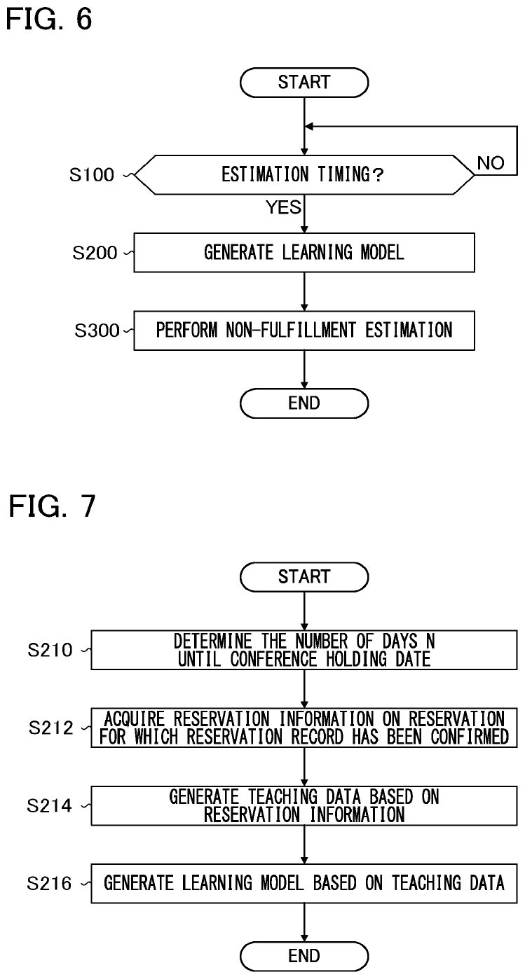

FIG. 7 is a flowchart illustrating an example of operations of the management apparatus 100 when a learning model is generated. That is, FIG. 7 is a flowchart illustrating an example of the process (generation of a learning model) at Step S200 illustrated in FIG. 6. For example, the process at Step S210 is performed when the determination result at Step S100 in FIG. 6 is YES.

At Step S210, the model generator 112 determines the number of days N from originating the date of the current time point until the conference holding date indicated by the conference holding date and time of reservation information in a reservation as a subject of a non-fulfillment estimation.

Next, at Step S212, the model generator 112 acquires reservation information of a reservation for which the reservation record has been confirmed, until the current time point.

Next, at Step S214, as described with reference to FIG. 4 and the like, the model generator 112 generates teaching data based on information in a period before a date predated by N days from the conference holding date and time indicated by reservation information among the reservation information acquired at Step S212. For example, the model generator 112 extracts the feature amount described with reference to FIG. 3 from information in the period before a date predated by N days from the conference holding date and time indicated by reservation information to generate teaching data including the extracted feature amount and reservation records. The date predated by N days from the conference holding date and time is an example of the first timing and the conference holding date and time is an example of the second timing and the origination.

Next, at Step S216, the model generator 112 generates a learning model based on the teaching data generated at Step S214. For example, when the learning model is a decision tree, as described with reference to FIG. 5, the model generator 112 generates a decision tree used for a non-fulfillment estimation by repeating changes in the node, the conditions, the estimation value, and the like of the decision tree so as to reduce errors. In this case, the first decision tree may be the latest decision tree among decision trees used for non-fulfillment estimations performed in the past or may be a decision tree prepared in advance.

In this manner, as a series of process from Step S210 to Step S216 is performed, a learning model corresponding to an estimation timing and a use timing is generated. After ending the series of processes from Step S210 to Step S216, the process shifts to Step S300 in FIG. 6.

When a non-fulfillment estimation is performed with respect to a plurality of reservations each having a mutually different number of days from the estimation timing to the use timing, the series of processes from Step S210 to Step S216 is repeated until a plurality of learning models each having a mutually different number of days from the estimation timing to the use timing are generated.

The operations of the management apparatus 100 when a learning model is generated are not limited to the example illustrated in FIG. 7. For example, at Step S212, the model generator 112 may acquire information on a period before a date predated by N days from the conference holding date and time indicated by reservation information among reservation information on reservations for which the reservation record has been confirmed until the current time point.

As described above, in the first embodiment, the management apparatus 100 that manages reservations of conference rooms includes the model generator 112 that generates a learning model used for a non-fulfillment estimation to estimate whether reservations of conference rooms are not fulfilled and the cancellation estimator 114 that performs a non-fulfillment estimation using a learning model. With this configuration, in the present embodiment, whether a reservation of a conference room is canceled is estimated at a timing (an estimation timing at which a non-fulfillment estimation is performed) before a scheduled start time of the conference. By this configuration, the reservation management system 10 including the management apparatus 100 may prompt the reservation holder of a reservation of a conference room having been estimated to be canceled to cancel the reservation with the reservation management system 10. In this manner, in the present embodiment, as compared to a case in which whether a conference room is used as reserved is not known until the scheduled start time of the conference, usability of the reservation management system 10 can be improved.

In the present embodiment, the learning model generated by the model generator 112 is a learning model corresponding to an estimation timing at which a non-fulfillment estimation is performed and a use timing of a conference room designated by a reservation as a subject of the non-fulfillment estimation.

For example, the model generator 112 generates a learning model using teaching data based on record information indicating a record as to whether a reservation of a conference room has been fulfilled and reservation information regarding a reservation corresponding to the record indicated by the record information. When the use timing is N days (N is a natural number equal to or greater than 1) after the estimation timing, reserved information used for generating the teaching data does not include information corresponding to reservations made in a period N days before the use date of a conference room designated by a reservation corresponding to the record indicated by the record information.

By this configuration, in the present embodiment, it is possible to match reservation information used for generating teaching data (more specifically, a feature amount extracted from reservation information and included in teaching data) and reservation information used for a non-fulfillment estimation (more specifically, a feature amount input to a learning model). Accordingly, in the present embodiment, it is possible to prevent decrease of accuracy in the results of estimations using a learning model.

Information regarding participants using a conference room may be included in the reservation information. In this case, as a breakdown of a list of replies with respect to conference holding notification, when the number of scheduled absentees is greater than the number of scheduled attendees, the probability of reservation being canceled is higher as compared to a case in which the number of scheduled absentees is smaller than the number of scheduled attendees. In this case, in a mode in which reservation information includes information regarding participants using a conference room, as compared to a mode in which the reservation information does not include information regarding participants using a conference room, accuracy in the results of estimations using a learning model can be improved.

Information indicating whether persons from outside a company are included in the participants of a conference may be included in the reservation information. In a case in which persons from outside a company are included in the participants of a conference, as compared to a case in which persons from outside a company are not included in the participants of a conference, the probability of a reservation being canceled is low. In this case, in a mode in which information indicating whether persons from outside a company are included in the participants of a conference is included in the reservation information, as compared to a mode in which information indicating whether persons from outside a company are included in the participants of a conference is not included in the reservation information, accuracy in the results of estimations using a learning model can be improved.

### 2. Second Embodiment

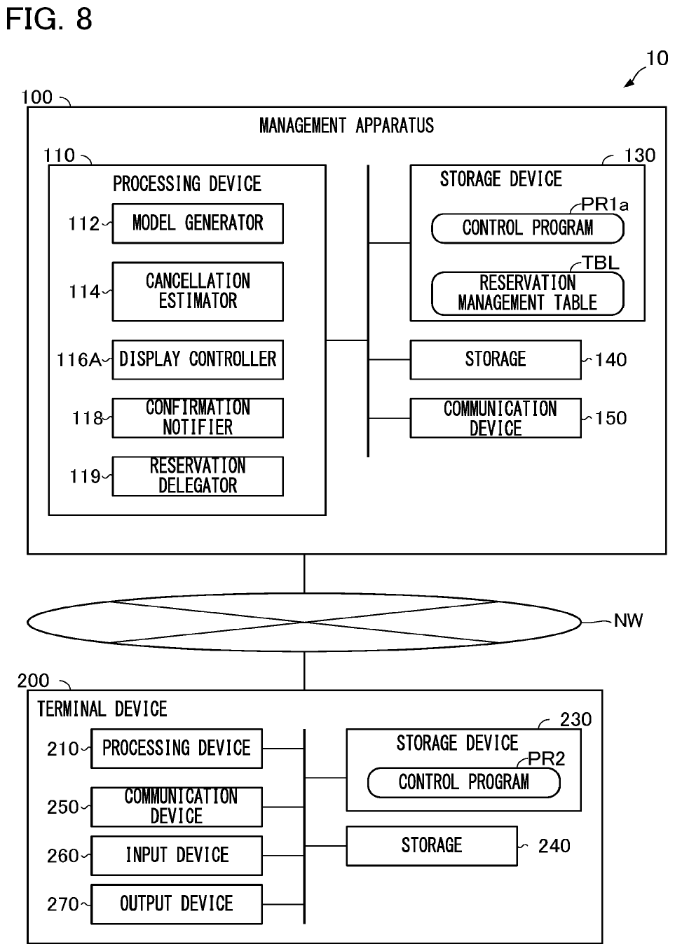

FIG. 8 is a block diagram illustrating an overall configuration of the reservation management system 10 including the management apparatus 100 according to a second embodiment. Elements substantially the same as the elements described with reference to FIG. 1 to FIG. 7 are denoted with like reference signs, and detailed explanations thereof are omitted. Similarly to the reservation management system 10 illustrated in FIG. 1, the reservation management system 10 illustrated in FIG. 8 includes the management apparatus 100 and the terminal device 200 that are communicable with each other via the network NW. The terminal device 200 illustrated in FIG. 8 is the same as the terminal device 200 illustrated in FIG. 1.

The management apparatus 100 illustrated in FIG. 8 has the same configuration as that of the management apparatus 100 illustrated in FIG. 1. For example, the management apparatus 100 includes the processing device 110, the storage device 130, the storage 140, and the communication device 150.

However, a control program PR1a stored in the storage device 130 is different from the control program PR1 illustrated in FIG. 1. Therefore, for example, functions realized by the processing device 110 executing the control program PR1a stored in the storage device 130 are different from the functions realized by the processing device 110 illustrated in FIG. 1.

The processing device 110 illustrated in FIG. 8 is substantially the same as the processing device 110 illustrated in FIG. 1, except for executing the control program PR1a instead of the control program PR1 illustrated in FIG. 1. For example, the processing device 110 reads out the control program PR1a from the storage device 130 and executes the read out control program PR1a, thereby functioning as the model generator 112, the cancellation estimator 114, a display controller 116A, a confirmation notifier 118, and a reservation delegator 119. The model generator 112 and the cancellation estimator 114 are substantially the same as the model generator 112 and the cancellation estimator 114 illustrated in FIG. 1. Therefore, in FIG. 8, the display controller 116A, the confirmation notifier 118, and the reservation delegator 119 are described.

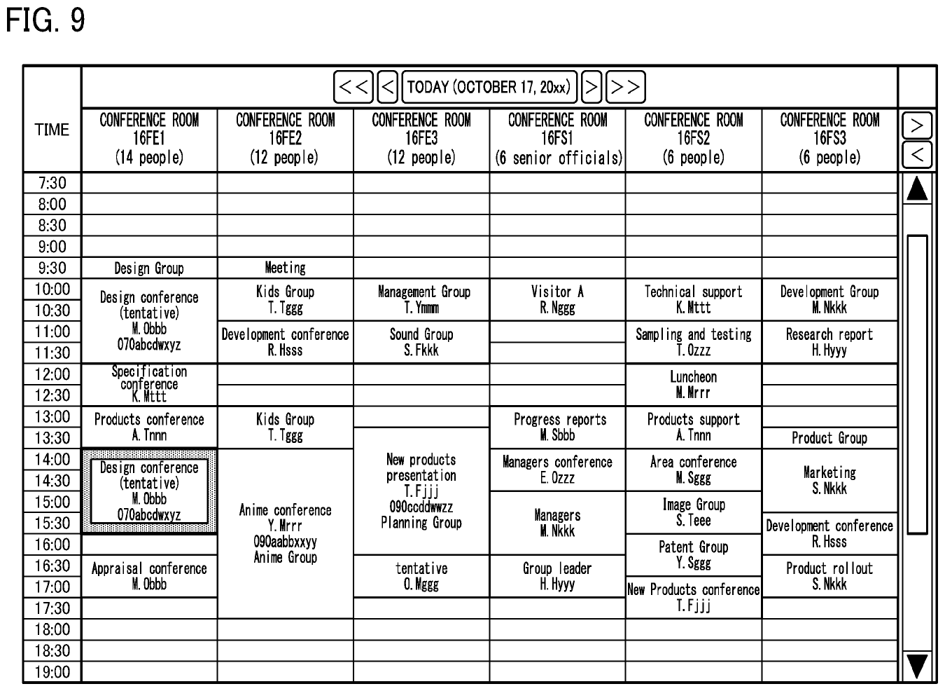

Similarly to the display controller 116 illustrated in FIG. 1, the display controller 116A generates display information for displaying a schedule screen that shows a reservation status of a conference room, and then transmits the generated display information to the terminal device 200. Furthermore, the display controller 116A displays a reservation status on the schedule screen in a mode in which estimation results of the cancellation estimator 114 are visibly recognized. An example of the schedule screen is described later with reference to FIG. 9.

When the cancellation estimator 114 estimates that a reservation of a conference room is canceled, the confirmation notifier 118 issues a confirmation as to whether the conference room is used as reserved to the reservation holder of the reservation having been estimated to be canceled. For example, the confirmation notifier 118 transmits an electronic mail to confirm whether the conference room is used as scheduled to a reservation holder of a reservation having an estimation value of cancellation probability equal to or greater than a predetermined value via the communication device 150. In the following descriptions, the electronic mail to confirm whether a conference room is used as scheduled is also referred to as a “confirmation e-mail.” A link to display a schedule screen may be set in the confirmation e-mail.

The reservation holder having received a confirmation e-mail may cancel the reservation with the reservation management system 10 or transmit to the management apparatus 100 a reply e-mail notifying that the reservation is not canceled. When the management apparatus 100 receives a reply e-mail notifying that the reservation is not canceled, information indicating reception of a reply e-mail notifying that the reservation is not canceled may be used as a feature amount (a feature amount input to a learning model) at the time of performing the next non-fulfillment estimation. By this configuration, at the next non-fulfillment estimation, the probability that an estimation value of the probability of the reservation corresponding to the reply e-mail being canceled is less than a predetermined value becomes higher as compared to a case in which the reply e-mail is not used for the non-fulfillment estimation.

The confirmation notifier 118 may transmit, each time a non-fulfillment estimation is performed, a confirmation e-mail to a reservation holder of a reservation having an estimation value of probability that the reservation is canceled is greater than a predetermined value. In this case, since a confirmation e-mail is transmitted to the reservation holder until the estimation value of cancellation probability becomes less than a predetermined value or the reservation is canceled, occurrence of cancellation without notice is reduced.

When a non-fulfillment estimation is performed at a date a predetermined number of days before a conference holding date and time, the confirmation notifier 118 may transmit a confirmation e-mail to a reservation holder of a reservation having an estimation value of cancellation probability greater than a predetermined value. In this case, as compared to a case in which a confirmation e-mail is transmitted to a subject reservation holder each time a non-fulfillment estimation is performed, it is possible to avoid a case in which confirmation e-mails with the same contents are transmitted to the same reservation holder.

When the cancellation estimator 114 estimates that a reservation of a conference room is canceled, the reservation delegator 119 enables the reservation estimated to be canceled to be delegated to an applicant among a plurality of users of the reservation management system 10 who applies for the use of the conference room. An example of a reservation delegating method is described later with reference to FIG. 9.

Functional blocks included in the processing device 110 are not limited to the example illustrated in FIG. 8. For example, the processing device 110 may include the display controller 116 illustrated in FIG. 1 instead of the display controller 116A. Furthermore, the confirmation notifier 118 may be omitted. The reservation delegator 119 may be omitted.

FIG. 9 is an explanatory diagram illustrating an example of a schedule screen. On the schedule screen illustrated in FIG. 9, reservation statuses of each conference room on Oct. 17, 20xx are displayed. In the example illustrated in FIG. 9, uses and reservations of conference rooms are managed in units of 30 minutes. In FIG. 9, a case will be given in which the cancellation estimator 114 has estimated that a conference titled “Design conference (tentative)” is canceled.

The reservation status of a conference room named “Conference room 16FE1” is displayed in a column displayed as “Conference room 16FE1.” Specifically, as for the conference room “Conference room 16FE1,” for example, a conference titled “Design Group” using the conference room from a time “9:30” to a time “10:00” is reserved. For example, when a user checking the schedule screen performs an operation for selecting a section displayed as “Design Group,” detailed information regarding the conference “Design Group” (such as the reservation holder's name, affiliation, and contact, and participants of the conference) is displayed.

Detailed information regarding a conference may be displayed on a schedule screen in the form of a pop-up and the like or be displayed in a window separate from the window in which the schedule screen is displayed.

In the present embodiment, the display controller 116A displays reservation statuses on a schedule screen in a mode in which estimation results of the cancellation estimator 114 are visually recognized. For example, as the mode of displaying estimation results of the cancellation estimator 114 in a visibly recognizable manner, a mode in which a reservation estimated to be canceled is highlighted (highlighted display) may be employed. In the example illustrated in FIG. 9, a reservation of a conference titled “Design conference (tentative)” (a reservation estimated to be canceled) is displayed with hatching. In this manner, reservations estimated to be canceled are displayed distinctly different from reservations not estimated to be canceled.

When a user other than the reservation holder having reserved a conference titled “Design conference (tentative)” performs an operation for selecting a section displayed as “Design conference (tentative)” on the schedule screen, other than detailed information regarding the conference “Design conference (tentative),” an operation button to request reservation delegating and the like may be displayed. For example, the reservation delegator 119 enables the reservation of the conference “Design conference (tentative)” to be delegated to an applicant who applies for the use of the conference room. When a reservation of a display subject of detailed information regarding a conference is enabled to be delegated, the display controller 116A generates display information for displaying an operation button to request reservation delegating other than detailed information regarding the conference.

When an operation button to request reservation delegating of a conference room scheduled to be used for a conference “Design conference (tentative)” is operated, the reservation delegator 119 may transmit an electronic mail requesting reservation delegating to the reservation holder of the conference. In the following descriptions, the electronic mail requesting reservation delegating may be referred to as “delegating e-mail.”

For example, a URL (Uniform Resource Locator) indicating the location of selection operation information for selecting whether reservation delegating of the conference “Design conference (tentative)” is approved is described in the delegating e-mail. A link is set to the URL indicating the location of selection operation information.

Furthermore, parameters for identifying a person transmitting the delegating e-mail (that is, a user requesting reservation delegating) and a person receiving the delegating e-mail (that is, the reservation holder of the reservation as a delegating subject) is added to the URL indicating the location of selection operation information.

When the reservation holder of the reservation as a delegating subject clicks the URL indicating the location of selection operation information, the display controller 116A causes the output device 270 of the reservation holder's terminal device 200 to display a window in which an operation button to select whether reservation delegating of the conference “Design conference (tentative)” is approved. In this case, the reservation delegator 119 specifies the transmitting person and the receiving person of the delegating e-mail based on the parameters added to the URL indicating the location of selection operation information. Subsequently, when the reservation holder performs an operation for selecting approval of reservation delegating of the conference “Design conference (tentative),” the reservation delegator 119 changes the right holder of reserving the conference room scheduled to be used in the conference “Design conference (tentative)” to the person transmitting the delegating e-mail. The reservation delegator 119 then notifies the person transmitting the delegating e-mail of a fact that reservation delegating has been approved via an electronic mail and the like.

Furthermore, when the reservation holder performs an operation for selecting non-approval of reservation delegating of the conference “Design conference (tentative),” the reservation delegator 119 notifies the transmitting person of the delegating e-mail of a fact that reservation delegating has not been approved via an electronic mail and the like.

When the reservation holder having reserved the conference titled “Design conference (tentative)” performs an operation for selecting a section displayed as “Design conference (tentative),” information for changing the reservation contents of the conference “Design conference (tentative)” may be displayed. In this case, as a portion of the information for changing the reservation contents of the conference, an operation button to select whether the conference room is canceled or is used as reserved may be displayed. When the operation button to select whether the conference is canceled or is used as reserved is operated, the reply e-mail described with reference to FIG. 8 may be transmitted to the management apparatus 100. Furthermore, when an operation for selecting to use the conference as reserved is performed, the reservation delegator 119 may cancel the setting such that the reservation is enabled to be delegated.

The contents displayed on the schedule screen are not limited to the example illustrated in FIG. 9. For example, in addition to reservation statuses of conference rooms, use statuses of conference rooms may be displayed on the schedule screen. When a conference room scheduled to be used is not being used at the time when display on the schedule screen is updated, the display controller 116A may highlight the reservation of the unused conference room.

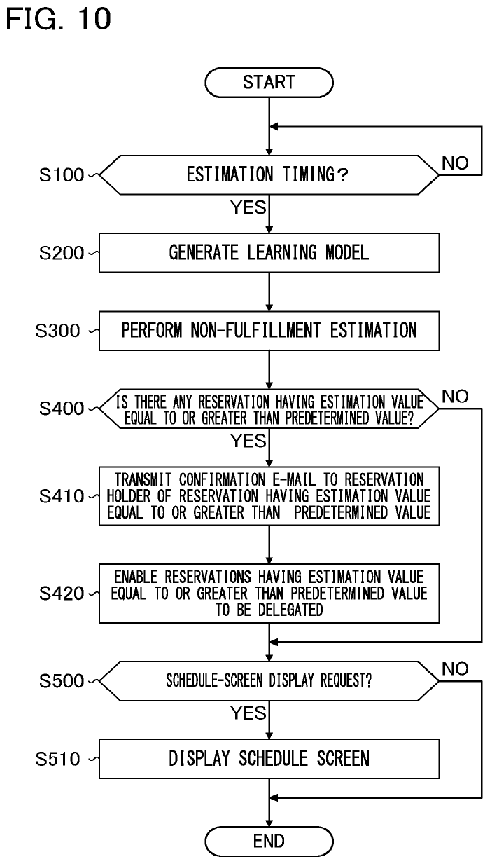

FIG. 10 is a flowchart illustrating an example of operations of the management apparatus 100 illustrated in FIG. 8. The operations illustrated in FIG. 10 are substantially the same as the operations illustrated in FIG. 6 apart from a fact that a series of processes from Step S400 to Step S420 and a series of processes at Step S500 and Step S510 are added to the operations illustrated in FIG. 6. As for the operations described with reference to FIG. 6, detailed descriptions thereof are omitted. The process at Step S400 is performed, for example, after the process at Step S300 is performed.

At Step S400, the confirmation notifier 118 determines whether there is any reservation having an estimation value equal to or greater than a predetermined value among reservations for which a non-fulfillment estimation is performed at Step S300. When the result of determination at Step S400 is YES, the confirmation notifier 118 proceeds the process to Step S410. When the result of determination at Step S400 is NO, the confirmation notifier 118 proceeds the process to Step S500.

At Step S410, as described with reference to FIG. 8, the confirmation notifier 118 transmits a confirmation e-mail to the reservation holder of a reservation having an estimation value equal to or greater than a predetermined value.

Next, at Step S420, as described with reference to FIG. 9, the reservation delegator 119 enables reservations having an estimation value equal to or greater than a predetermined value to be delegated.

Next, at Step S500, the display controller 116A determines whether the management apparatus 100 has received a schedule-screen display request from the terminal device 200. When the determination result at Step S500 is YES, the display controller 116A proceeds the process to Step S510. When the determination result at Step S500 is NO, the display controller 116A ends the process regarding the non-fulfillment estimation.

At Step S510, the display controller 116A displays a schedule screen. For example, the display controller 116A generates display information for displaying a schedule screen and transmits the generated display information to the terminal device 200 having requested the display of a schedule screen. By this process, a schedule screen is displayed on the output device 270 of the terminal device 200 having requested the display of a schedule screen.

The operations of the management apparatus 100 are not limited to the example illustrated in FIG. 10. The process at Step S410 may be performed after the process at Step S420 is performed, or it may be performed in parallel with the process at Step S420. Furthermore, the process at Step S410 may be omitted. Alternatively, the process at Step S420 may be omitted.

Furthermore, a series of processes at Step S500 and Step 510 may be performed before the process at Step S100 is performed, or may be performed in parallel with a series of processes from Step S100 to Step S420.

As described above, also in the second embodiment, effects substantially the same as those in the first embodiment can be obtained. In the second embodiment, the display controller 116A displays reservation statuses on a schedule screen in a mode in which estimation results of the cancellation estimator 114 are visibly recognized. By this configuration, in the present embodiment, it is possible to cause a user checking the schedule screen to easily ascertain whether a certain reservation is a reservation having a high probability of being canceled. Accordingly, in the present embodiment, usability of the reservation management system 10 can be improved.

In the second embodiment, the processing device 110 functions as the confirmation notifier 118. When the cancellation estimator 114 has estimated that a reservation of a conference room is not fulfilled, the confirmation notifier 118 notifies the reservation holder of the reservation estimated not to be fulfilled of a confirmation as to whether the conference room is to be used as reserved. As a result, in the present embodiment, it is possible to avoid situations in which cancellation of a reservation is forgotten.

For example, a conference room not to be used as reserved is properly canceled before the day of the conference (the conference holding date and time designated by a reservation). In this case, an applicant who applies for the use of the conference room can reserve the canceled conference room. In this manner, in the present embodiment, usability of the reservation management system 10 can be improved. Furthermore, in the present embodiment, since a conference room having been canceled before the day of the conference can be reserved by an applicant who applies for the use of the conference room, usage efficiency of conference rooms can be improved.

In the second embodiment, the processing device 110 functions as the reservation delegator 119. When the cancellation estimator 114 estimates that a reservation of a conference room is not fulfilled, the reservation delegator 119 enables the reservation estimated not to be fulfilled to be delegated to an applicant who applies for use of the conference room. For example, the reservation delegator 119 enables reservations to be delegated to applicants in the reservation management system 10. In this case, the reservation holder of the reservation estimated not to be fulfilled and the applicant who applies for the use of the conference room can perform procedures to delegate the reservation on the reservation management system 10. As a result, in the present embodiment, usability of the reservation management system 10 can be improved.

### 3. Modification

The present invention is not limited to the embodiments exemplified above. Specific modified modes are exemplified below. Two or more modes freely selected from the following examples may be combined with one another.

### First Modification

In the first embodiment and the second embodiment described above, there are no particular descriptions on how many days it is predated (prior to) from an estimation timing to acquire reservation information when teaching data is generated; however, when reservation information is acquired, how many days it is predated from an estimation timing may be set in advance. In this case, as compared to a case in which how many days it is predated from an estimation timing to acquire reservation information is not set, it is possible to reduce the load of processing regarding generation of teaching data.

### Second Modification

In the second embodiment described above, an example of transmitting a confirmation e-mail to a reservation holder of a reservation having an estimation value of cancellation probability equal to or greater than a predetermined value has been described; however, the present invention is not limited to such a mode. For example, a reception time limit of a reply (for example, a reply e-mail) indicating that the reservation is not canceled and a warning message that the reservation will be automatically canceled unless there is a reply within the reception time limit may be described in the confirmation e-mail. In this case, the management apparatus 100 automatically cancels the reservation corresponding to a confirmation e-mail not having any reply transmitted thereto within the reception time limit. By this configuration, in the second modification, conference rooms can be used by applicants who apply for the use of conference rooms.

Alternatively, the confirmation notifier 118 may transmit the confirmation e-mail described above to a reservation holder of a reservation having an estimation value of cancellation probability equal to or greater than a first value (for example, the predetermined value described above), and may transmit a confirmation e-mail including a warning message that the reservation is automatically canceled to a reservation holder of a reservation having an estimation value of cancellation probability equal to or greater than a second value, which is greater than the first value. In this case, it is possible to avoid situations such that a conference room to be used as reserved is automatically canceled.

### Third Modification

In the second embodiment described above, an example in which an operation for delegating a reservation is performed between a reservation holder of a reservation as a delegating subject (a reservation estimated to be canceled) and an applicant who applies for the use of a conference room corresponding to the reservation as a delegating subject has been described; however, the present invention is not limited to such a mode.

For example, the management apparatus 100 may receive, from an applicant who applies for the use of a conference room, cancellation waiting indicating waiting for cancellation of an already reserved conference room. The management apparatus 100 may receive cancellation waiting for each conference room or receive cancellation waiting for each of the types of conference rooms (for example, types categorized based on the size, the facilities, and the like of conference rooms).

When a reservation as a subject of cancellation waiting is canceled, the management apparatus 100 performs a delegating process of allocating a conference room corresponding to the canceled reservation to a reservation made by a cancellation waiting user, instead of performing a cancellation reflecting process of reflecting the fact that the reservation has been canceled on a schedule screen. The delegating process may be performed by the reservation delegator 119, for example. When there is no cancellation waiting user, for example, the cancellation reflecting process is performed by the display controller 116A. In the third modification, effects substantially the same as those in the second embodiment can be obtained. Furthermore, in the third modification, operations performed by a user requesting reservation delegating can be made simple.

### 4. Other Matters

(1) In the foregoing embodiments, the memory 160 is a recording medium readable by the processor 110, such as ROM and RAM. However, the memory 160 may be flexible disks, magneto-optical disks (e.g., compact disks, digital multi-purpose disks, Blu-ray (registered trademark) discs, smart cards, flash memory devices (e.g., cards, sticks, key drives), Compact Disc-ROMs (CD-ROMs), registers, removable discs, hard disks, floppy (registered trademark) disks, magnetic strips, databases, servers, or other suitable storage mediums. The program may be transmitted by a network or system via telecommunication lines.

(2) In the foregoing embodiments, information, signals and the like may be presented by use of various techniques. For example, data, instructions, commands, information, signals, bits, symbols, chips, and the like may be presented by freely selected combination of voltages, currents, electromagnetic waves, magnetic fields or magnetic particles, light fields or photons.

(3) In the foregoing embodiments, input and/or output information, etc., may be stored in a specific location (e.g., memory) or may be managed by use of a management table. The information, etc., that is input and/or output may be overwritten, updated, or appended. The information, etc., that is output may be deleted. The information, etc., that is input may be transmitted to other devices.

(4) In the foregoing embodiments, determination may be made by values that can be represented by one bit (0 or 1), may be made in Boolean values (true or false), or may be made by comparing numerical values (for example, comparison with a predetermined value).

(5) The order of processes, sequences, flowcharts, etc., that have been used to describe the embodiments may be changed as long as they do not conflict. For example, although a variety of methods has been illustrated in this disclosure with a variety of elements of steps in exemplary orders, the specific orders presented herein are by no means limiting.

(6) Each of functions shown in FIGS. 1 and 8 is realized by freely selected combination of at least one of hardware and software. The method of realizing each functional block is not limited thereto. That is, each functional block may be implemented by one piece of device that is physically and/or logically aggregated. Alternatively, each functional block may be realized by directly and/or indirectly connecting two or more physically and/or logically separate pieces of device (by using cables and/or radio, for example), and using these devices. The functional block may be realized by combining the software with one device described above or these devices.

The communication device 170 is hardware (a transmitting and receiving device) for communicating between computers via at least one of a wired network and a wireless network. The communication device 170 is referred to as, for example, a network device, a network controller, a network card, or a communication module. The communication device 170 may include a high-frequency switch, duplexers, filters, or frequency synthesizers to realize Frequency Division Duplexing (FDD) and/or Time Division Duplexing (TDD: Time Division (Duplexing).

(7) In the foregoing embodiments, programs, whether referred to as software, firmware, middleware, microcode, hardware description language, or by any other name, are instructions, instruction sets, code, code segments, or program code. It should be interpreted broadly to mean programs, subprograms, software modules, applications, software applications, software packages, routines, subroutines, objects, executable files, execution threads, procedures, functions, etc.

Software, instructions and so forth may be transmitted and received via communication media. For example, when software is transmitted from a website, a server, or other remote sources, by using wired technologies such as coaxial cables, optical fiber cables, twisted-pair cables, and digital subscriber lines (DSL), and/or wireless technologies such as infrared radiation, radio and microwaves, etc., these wired technologies and/or wireless technologies are also included in the definition of communication media.

(8) In the foregoing aspects, the terms “system” and “network” are used interchangeably.

(9) The information and parameters described in this disclosure may be represented by absolute values, may be represented by relative values with respect to predetermined values, or may be represented by using other pieces of applicable information. For example, radio resources may be specified by predetermined indices. The names used for parameters in this specification are in no respect limiting. In addition, equations and/or the like to use these parameters may be other than those explicitly disclosed in this specification. For example, since a variety of channels (for example, PUCCH, PDCCH, etc.) and information elements (for example, TPC) can be identified by any suitable names, a variety of names to assign to these various channels and information elements are in no respect limiting.

(10) In the foregoing embodiments, the terminal device 200 may be a mobile station (MS). A mobile station (mobile device) may be referred to, by one skilled in the art as a “subscriber station”, a “mobile unit”, a “subscriber unit”, a “wireless unit”, a “remote unit”, a “mobile device”, a “wireless device”, a “wireless communication device”, a “remote device”, a “mobile subscriber station”, a “access terminal”, a “mobile terminal”, a “wireless terminal”, a “remote terminal”, a “handset”, a “user agent”, a “mobile client”, a “client”, or some other suitable terms. The terms “mobile station”, “user terminal”, “user equipment (UE)”, “terminal”, and the like may be used interchangeably in the present disclosure.

(11) In the foregoing embodiments, the terms “connected” and “coupled”, or any modification of these terms, may mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be replaced with “access.” As used in this specification, two elements may be considered “connected” or “coupled” to each other by using one or more electrical wires, cables and/or printed electrical connections, and to name a number of non-limiting and non-inclusive examples, by using electromagnetic energy, such as electromagnetic energy having wavelengths in radio frequency regions, microwave regions and optical (both visible and invisible) regions.

(12) In the foregoing embodiments, the phrase “based on” as used in this specification does not mean “based only on”, unless specified otherwise. In other words, the phrase “based on” means both “based only on” and “based at least on.”

(13) The term “determining” as used in this specification may encompass a wide variety of actions. For example, the term “determining” may be used when practically “determining” that some act of calculating, computing, processing, deriving, investigating, looking up (for example, looking up a table, a database, or some other data structure), ascertaining and so forth has taken place. Furthermore, “determining” may be used when practically “determining” that some act of receiving (for example, receiving information), transmitting (for example, transmitting information), inputting, outputting, accessing (for example, accessing data in a memory) and so forth has taken place. Furthermore, “determining” may be used when practically “determining” that some act of receiving (for example, receiving information), transmitting (for example, transmitting information), inputting, outputting, accessing (for example, accessing data in a memory) and so forth has taken place. That is, “determining” may be used when practically determining to take some action. The term “judgment (decision)” may be replaced with “assuming”, “expecting”, “considering”, etc.

(14) As long as terms such as “include”, “comprise” and modifications of these are used in the foregoing embodiments, these terms are intended to be inclusive, in a manner similar to the way the term “provide” is used. Furthermore, the term “or” as used in this specification or in claims is not intended to be an exclusive disjunction.

(15) In the present disclosure, when articles such as, for example, “a”, “an” and “the” are added in the English translation, these articles may also indicate plural forms of words, unless the context clearly indicates otherwise.

(16) In this disclosure, the phrase “A and B are different” may mean “A and B are different from each other.” The phrase “A and B are different from C, respectively” may mean that “A and B are different from C.” Terms such as “separated” and “combined” may be interpreted in the same way as “different.”

(17) The examples and embodiments illustrated in this specification may be used individually or in combination, which may be altered depending on the mode of implementation. A predetermined piece of information (for example, a report to the effect that something is “X”) does not necessarily have to be indicated explicitly, and may be indicated in an implicit way (for example, by not reporting this predetermined piece of information, by reporting another piece of information, etc.).

Although the disclosure is described in detail, it should be obvious to one skilled in the art that the present invention is by no means limited to the embodiments described in this specification. The present disclosure can be implemented with a variety of corrections and in a variety of modifications, without departing from the spirit and scope of the present invention defined as in the recitations of the claims. Consequently, the description in this specification is provided only for the purpose of explaining examples and should by no means be construed to limit the present invention in any way.

### DESCRIPTION OF REFERENCE SIGNS

10 . . . reservation management system, 100 . . . management apparatus, 110 . . . processing device, 112 . . . model generator, 114 . . . cancellation estimator, 116, 116A . . . display controller, 118 . . . confirmation notifier, 119 . . . reservation delegator, 130 . . . storage device, 140 . . . storage, 150 . . . communication device, 200 . . . terminal device, 210 . . . processing device, 230 . . . storage device, 240 . . . storage, 250 . . . communication device, 260 . . . input device, 270 . . . output device.

1. A management apparatus for managing facility reservations, comprising:
a generator configured to generate a learning model that is used for a non-fulfillment estimation to estimate whether a reservation of a facility will not be fulfilled, the learning model corresponding to:
an estimation timing at which the non-fulfillment estimation is performed, and
a use timing at which the facility designated by a reservation as a subject of the non-fulfillment estimation is used; and
an estimator configured to use the learning model to perform the non-fulfillment estimation.

2. The management apparatus according to claim 1, wherein:
the generator is configured to generate the learning model using teaching data, the teaching data being based on:
record information indicating a record as to whether a reservation of the facility has been fulfilled, and
reservation information regarding a reservation corresponding to a record indicated by the record information,
the reservation information does not include information corresponding to a reservation made during a first period,
the first period is a period from a first timing to a second timing,
the first timing being originated at a use timing of the facility designated by a reservation corresponding to a record indicated by the record information and being predated by a time corresponding to a second period, and
the second timing corresponding to the origination, and
the second period is a period from the estimation timing to the use timing of the facility designated by a reservation as a subject of the non-fulfillment estimation.

3. The management apparatus according to claim 2, wherein:
when the use timing of the facility designated by a reservation as a subject of the non-fulfillment estimation is N days (N is a natural number equal to or greater than 1) after the estimation timing, the second period is N days, and
the first period is a period until N days before a use date of the facility designated by a reservation corresponding to a record indicated by the record information.

4. The management apparatus according to claim 2, wherein the reservation information includes information regarding participants who use the facility.

5. The management apparatus according to claim 4, wherein when the facility is a conference room in a company, the reservation information includes information indicating whether the participants include a person from outside the company.

6. The management apparatus according to claim 1, further comprising a notifier configured to notify, when the estimator has estimated that a reservation of the facility is not fulfilled, a reservation holder of the reservation estimated not to be fulfilled of a confirmation as to whether the facility is used as reserved.

7. The management apparatus according to claim 1, further comprising a display controller configured to generate display information for displaying a schedule screen that shows a reservation status of the facility,
wherein the display controller displays the reservation status on the schedule screen in a mode in which an estimation result of the estimator is visibly recognized.

8. The management apparatus according to claim 1, further comprising a delegator configured to enable, when the estimator has estimated that a reservation of the facility is not fulfilled, a reservation estimated not to be fulfilled to be delegated to an applicant who applies for use of the facility.
